(19) United States
(12) Patent Application Publication
(10) Pub. No.: US 2015/0063444 A1
(43) Pub. Date: Mar. 5, 2015

(54) Dynamic quantization method for video encoding

(71) Applicant: FRANCE BREVETS, Paris (FR)

(72) Inventors: Stephane Allie, Saint Armel (FR); Marc Amstoutz, Rennes (FR); Christophe Berthelot, Erce Pres Liffre (FR)

(21) Appl. No.: 14/394,418

(22) PCT Filed: Apr. 11, 2013
(86) PCT No.: PCT/EP2013/057579

§ 371 Date: Oct. 14, 2014

(30) Foreign Application Priority Data
Apr. 16, 2012 (FR) 1253465

(51) Int. Cl. H04N 19/124; H04N 19/593; H04N 19/51; H04N 19/176; H04N 19/61

(52) U.S. Cl. CPC H04N 19/124; H04N 19/176; H04N 19/61; H04N 19/51; H04N 19/593
USPC 375/240.03

(57) ABSTRACT

The invention relates to a method for dynamic quantization of an image stream including transformed blocks, the method comprising a step for establishing a relationship (V₁₂, V₁₀, V₂₀) between at least one temporal predictive encoding source block (330, 323) of a first image (B₁, P₂) and one or more reference blocks (311, 312, 313, 314, 316, 321, 322, 323, 324) belonging to other images (I₀, P₂), the method comprising, for at least one of said transformed blocks, a step of quantization of said block wherein the level of quantization applied to this block is chosen (402) at least partly as a function of the relationship or relationships (V₁₂, V₁₀, V₂₀) established between this block and blocks belonging to other images. The invention applies notably to the improvement of video compression in order to improve the visual rendition of encoded videos.

The present invention relates to a dynamic quantization method for encoding image streams. It applies notably to the compression of videos according to the H.264 standard as defined by the ITU (International Telecommunication Union), otherwise denoted MPEG4-AVC by the ISO (International Organization for Standardization), and the H.265 standard, but more generally to video encoders capable of dynamically adjusting the level of quantization applied to image data according to their temporal activity in order to improve the visual rendition of the encoded video.

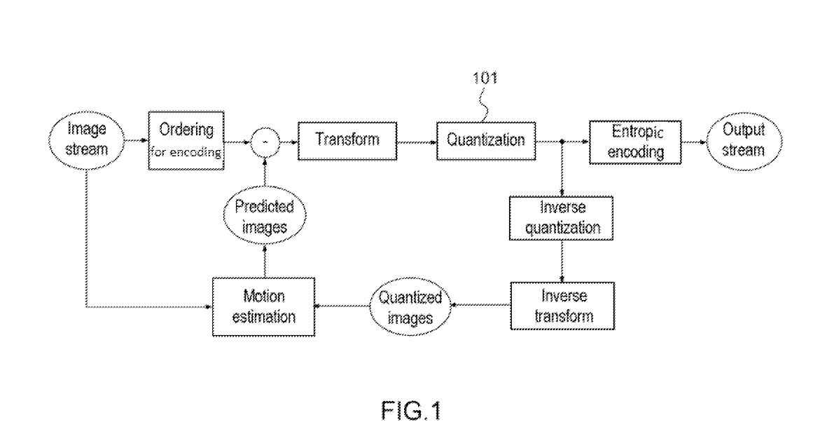

Quantization is a well-known step of MPEG video encoding which, after transposition of the image data into the transform domain, makes it possible to sacrifice the higher-order coefficients so as to substantially decrease the size of the data while only moderately affecting their visual rendition. Quantization is therefore an essential step of lossy compression. As a general rule, it is also the step that introduces the most significant artifacts into the encoded video, particularly when the quantization coefficients are very high. FIG. 1 illustrates the place 101 taken by the quantization step in an encoding method of MPEG type.

The encoding complexity and the quantity of information to be preserved to guarantee acceptable output quality vary over time, according to the nature of the sequences contained in the stream. Known methods make it possible to encode an audio or video stream by controlling the bitrate of the data produced at the output. However, at a constant bitrate, the quality of the video can fluctuate to the point of momentarily deteriorating beyond a visually acceptable level. One means of guaranteeing a minimum level of quality over the whole duration of the stream is then to increase the bitrate, which proves expensive and less than optimal in terms of hardware resource use.

Variable-bitrate streams can also be generated, the bitrate increasing in proportion to the complexity of the scene to be encoded. However, this type of stream is not always in agreement with the constraints imposed by the transport infrastructures. Indeed, it is frequently the case that a fixed bandwidth is allocated on a transmission channel, consequently forcing the allocation of a bandwidth equal to the maximum bitrate encountered in the stream in order to avoid transmission anomalies. Moreover, this technique produces a stream whose average bitrate is substantially higher, since the bitrate must be increased at least temporarily to preserve the quality of the most complex scenes.

To achieve a given quality of service under the constraints of a maximum bitrate limit, arbitration operations are carried out between the various areas of the image in order to achieve the best distribution of the available bitrate between these different areas. Conventionally, a model of the human visual system is used to carry out these arbitration operations on the basis of spatial criteria. For example, it is known that the eye is particularly sensitive to deterioration in the representation of visually simple areas, such as color fills or quasi-uniform radiometric areas. Conversely, highly textured areas, for example areas representing hairs or the foliage of a tree, are able to be encoded with poorer quality without this noticeably affecting the visual rendition for a human observer. Thus, conventionally, estimations of the spatial complexity of the image are carried out in such a way as to carry out quantization arbitration operations that only moderately affect the visual rendition of the video. In practice, in an image from the stream to be encoded, harsher quantization coefficients are applied for the areas of the image that are spatially complex than for the simple areas.

However, these techniques can prove insufficient, in particular when the competing constraints that are, on the one hand, the quality requirement for the visual rendition of an encoded video, and, on the other hand, the bitrate allocated to its encoding, are impossible to reconcile with known techniques.

One aim of the invention is to decrease the bandwidth occupied by an encoded stream for otherwise equal quality, or to increase the quality perceived by the observer of this stream for otherwise equal bitrate. For this purpose, the subject of the invention is a method for dynamic quantization of an image stream including transformed blocks, the method comprising a step for establishing a relationship of prediction between at least one temporal predictive encoding source block of a first image and one or more reference blocks belonging to other images, characterized in that it comprises, for at least one of said transformed blocks, a step of quantization of said block wherein the level of quantization applied to this block is chosen at least partly as a function of the relationship or relationships established between this block and blocks belonging to other images.

The transformed block to be quantized can be a source block or a reference block. The quantization method according to the invention makes it possible to advantageously make use of the temporal activity of a video to distribute the bits available for the encoding of an image or series of images to be quantized between the blocks of this image or series of images in a judicious manner. The method makes it possible to modify the distribution of the levels of quantization in real time, which gives it a dynamic nature, constantly adapting to the data represented by the stream. It should be noted that the level of quantization applied to a block can be the result of a set of criteria (spatial criteria, maximum bitrate etc.), the temporal activity criterion being combined with the other criteria to determine the level of quantization to be applied to one block.

The step that makes it possible to establish relationships between the blocks can be a function generating motion vectors for objects represented in said blocks, this function being able to be performed by a motion estimator present in a video encoder, for example. Furthermore, it should be noted that a reference block can belong either to an image temporally preceding the image to which the source block belongs, or to an image following the image to which the source block belongs.

According to an implementation of the quantization method according to the invention, the level of quantization to be applied to said block is chosen at least partly as a function of the number of relationships established between this block and blocks belonging to other images.

Advantageously, the level of quantization applied to said block to be quantized is increased if a number of relationships that is below a predetermined threshold have been established between this block and blocks belonging to other images or if no relationship has been established. Indeed, when an image block does not serve as a reference to one or more source blocks, then this block can be quantized more harshly by the method according to the invention, the eye being less sensitive to image data that are displayed over a very short time and that are set to disappear very quickly from the display.

Similarly, the level of quantization applied to said block to be quantized can be decreased if a number of relationships that is above a predetermined threshold have been established between this block and blocks belonging to other images.

According to an implementation of the quantization method according to the invention, said transformed block to be quantized is a source block, at least one of said relationships being a motion vector indicating a movement, between the first image containing said source block and the image containing the block referenced by said relationship, of objects represented in the area delimited by the source block, wherein the level of quantization is chosen at least partly as a function of the movement value indicated by said vector. As has already been mentioned above, the movement value can thus advantageously supplement other criteria that have already been employed elsewhere (level of texturing of the block to be encoded for example) to compute a quantization target level.

It is possible to increase the level of quantization applied to said block to be quantized if the movement indicated by said vector is above a predefined threshold. When the temporal activity at a place in the video is high, the eye can accommodate a high level of quantization, because it is less sensitive to losses of information over rapidly changing areas. The increase in quantization can be progressive as a function of the movement value indicated by the vector, for example proportional to the movement value.

Similarly, the level of quantization applied to said block to be quantized can be decreased if the movement indicated by said vector is below a predefined threshold. When an object is slow-moving, the visual representation of this object must be of good quality, which is why it is advisable to preserve an average level of quantization, or even to decrease it.

According to an implementation of the quantization method according to the invention, the level of quantization applied to a block included in an image not comprising any temporal predictive encoding block is increased if no relationship has been established between this block and a temporal predictive encoding block of another image.

According to an implementation of the quantization method according to the invention, the step of creating the relationships between a temporal predictive encoding source block of a first image and one or more reference blocks generates a prediction error depending on the differences in the data contained by the source block and by each of the reference blocks, and the level of quantization of said block to be quantized is modified according to the value of said prediction error.

Another subject of the invention is a method for encoding a stream of images forming a video, comprising a step of transforming the images by blocks, the encoding method comprising the execution of the dynamic quantization method as described above.

The encoding method can comprise a prediction loop capable of estimating the motion of the data represented in the blocks, wherein the step of creating the relationships between a temporal predictive encoding source block of a first image and one or more reference blocks is carried out by said prediction loop.

The stream can be encoded according to an MPEG standard for example. However, other formats such as DivX HD+ and VP8 may be employed.

According to an implementation of the encoding method according to the invention, the dynamic quantization method is applied cyclically over a reference period equal to one group of MPEG pictures.

Another subject of the invention is an MPEG video encoder configured to execute the encoding method as described above.

Other features will become apparent upon reading the following detailed description, which is given by way of example and non-limiting, with reference to the appended drawings, in which:

FIG. 1 shows a diagram illustrating the place taken by the quantization step in known encoding of MPEG type, this figure having already been presented above;

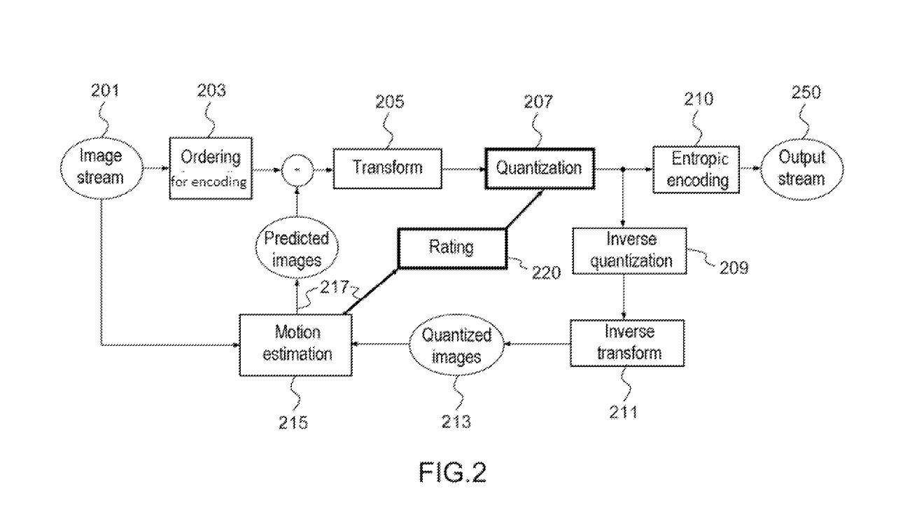

FIG. 2 shows a diagram illustrating the role of the dynamic quantization method according to the invention in encoding of MPEG type;

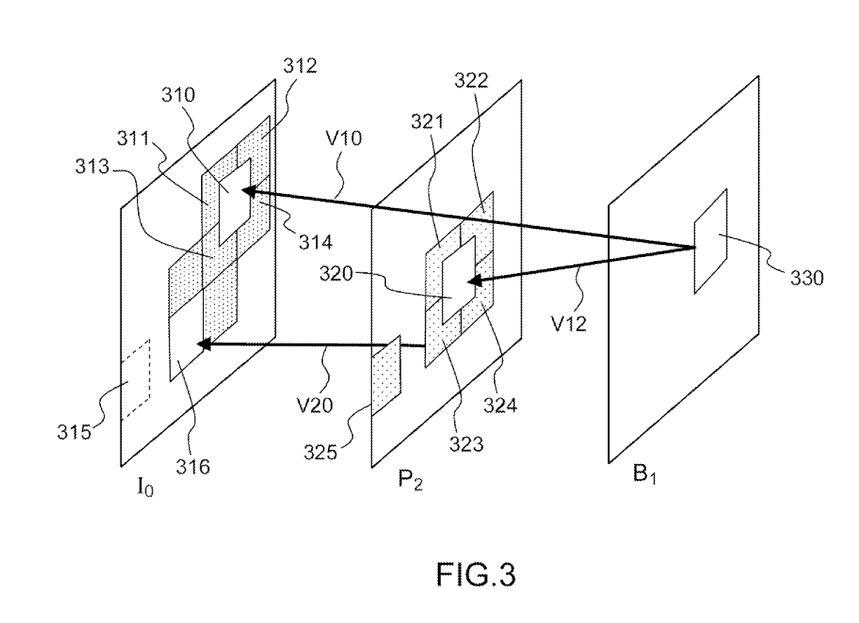

FIG. 3 a diagram illustrating the referencing carried out between the blocks of various images by a motion estimator;

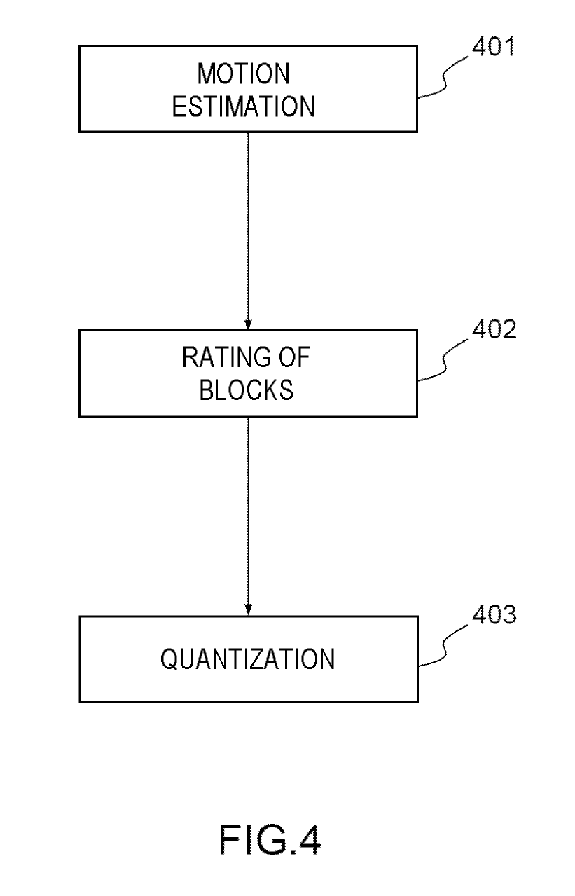

FIG. 4 shows a block diagram showing the steps of an example of a dynamic quantization method according to the invention.

The non-limiting example developed below is that of the quantization of a stream of images to be encoded according to the H.264/MPEG4-AVC standard. However, the method according to the invention can be applied more generally to any method of video encoding or transcoding applying quantization to transformed data, in particular if it is based on motion estimations.

FIG. 2 illustrates the role of the dynamic quantization method according to the invention in encoding of MPEG type. The steps in FIG. 2 are shown for purely illustrative purposes, and other methods of encoding and prediction can be employed.

Firstly, the images 201 from the stream to be encoded are put in order 203 to be able to carry out temporal prediction computations. The image to be encoded is divided into blocks, and each block undergoes a transformation 205, for example a discrete cosine transform (DCT). The transformed blocks are quantized 207 and then entropic encoding 210 is carried out to produce the encoded stream 250 at the output. The quantization coefficients applied to each block can be different, which makes it possible to choose the distribution of bitrate desired in the image as a function of the area.

Moreover, a prediction loop makes it possible to produce predicted images within the stream in order to decrease the quantity of information required for encoding. The temporally predicted images, often called “inter” frames, comprise one or more temporal predictive encoding blocks. By contrast, the “intra” frames, often denoted “I”, only comprise spatial predictive encoding blocks. The images of inter type comprise “P” frames, which are predicted from past reference images, and “B” (for “Bi-predicted”) frames, which are predicted both from past images but also from future images. At least one image block of inter type references one or more blocks of data present in one or more other past and/or future images.

The prediction loop in FIG. 2 comprises, in succession, inverse quantization 209 of the data resulting from the quantization 207 and an inverse DCT 211. The images 213 resulting from the inverse DCT are transmitted to a motion estimator 215 to produce motion vectors 217.

As recalled above in the introduction, conventional encoding methods generally apply quantization on the basis of spatial criteria. The method according to the invention makes it possible to improve the use of the bandwidth by dynamically adapting the quantization coefficients applied to a portion of an image to be encoded as a function of the temporal evolution of the data represented in this image portion, in other words as a function of the existence and the position of these data in the images that act as a prediction reference for the image to be encoded. Advantageously, this dynamic adjustment of the level of quantization over the areas of images to be encoded makes use of the information supplied by a motion estimator already present in the encoding algorithm of the video stream. Alternatively, this motion estimation is added in order to be able to quantize the data on the basis of temporal criteria in addition to the spatial criteria.

In the example in FIG. 2, the motion vectors 217 are transmitted to the quantization module 207, which is capable of exploiting these vectors with a view to improving quantization, for example using a rating module 220. An example of a method that the quantization step 207 uses to make use of these motion vectors is illustrated below with reference to FIG. 3.

FIG. 3 illustrates the referencing carried out between the blocks of different images by a motion estimator.

In the example, three images I₀, P₂, B₁ are represented in the order of encoding of the video stream, the first image I₀ being an image of intra type, the second image P₂ being of predictive type, and the third image B₁ being of bi-predictive type. The order in which images are displayed is different from the order of encoding because the intermediate image P₂ is displayed last; the images are therefore displayed in the following order: first image I₀, third image B₁, second image P₂. Furthermore, each of the three images I₀, P₂, B₁ is divided into blocks.

Using techniques well-known to those skilled in art (radiometric correlation processes for example), a motion estimator makes it possible to determine whether blocks in a source image are present in reference images. It is understood that a block is “found” in a reference image when, for example, the image data of this block are very similar to data present in the reference image, without necessarily being identical.

In the example, a source block 330 present in the third image B₁ is found, on the one hand in the second image P₂, and on the other hand in the first image I₀. Frequently, the portion in the reference image that is the most similar to the source block of an image does not coincide with a block of the reference image as divided. For example, the portion 320 of the second image P₂ that is the most similar to the source block 330 of the third image B₁ straddles four blocks 321, 322, 323, 324 of the second image P₂. Similarly, the portion 310 of the first image I₀ that is the most similar to the source block 330 of the third image B₁ straddles four blocks 311, 312, 313, 314 of the first image I₀. The source block 330 is linked to each of the groups of four straddled blocks 321, 322, 323, 324 and 311, 312, 313, 314 by motion vectors V₁₂, V₁₀ computed by the motion estimator.

In the example, a block 323—which is partly covered by the image portion 320 of the second image P₂ that is the most similar to the source block 330 of the third image B₁—has a reference number 316 in the first image I₀. This block 323 is linked by a motion vector V20 which does not indicate any movement of this image portion from the first image I₀ to the second image P₂. In other words, the object represented in the image portion covered by this block 323 does not move between the first image I₀ and the second image P₂—which does not mean that the representation per se of this object has not been slightly modified, but the area of the first image I₀ wherein the object is most probably situated is the same area as in the second image P₂.

Certain blocks, such as a block 325 of the second image P₂, is not referenced by the image B1. The aforementioned examples thus show that several situations can be encountered for each block of a source image:
the block can be reproduced in a reference image, in the same area of the image (the image portion is immobile from one image to the next);
the block can be reproduced in a reference image in a different area from that wherein it is situated in the reference image (the image portion has moved from one image to the next);
the block cannot be found in any of the other images from the stream (the image portion is visible over a very short space of time).

The examples presented with reference to FIG. 3 only cover a search depth of two images, but, according to other implementations, the search depth of a block is greater. Preferably, it is advisable to consolidate the presence or the immobility of an image portion over several images, for example a group of images, or group of pictures (GOP) as defined by the MPEG4-AVC standard.

Each of these situations gives rise to a different perception in the human observer. Indeed, when an image remains fixed over a long enough duration, the eye becomes more demanding with regard to image quality. This is for example the case of a logo, such as that of a television channel, overlaid on a program. If this logo is visually deteriorated, it is very probable that the television viewer will notice this. It is therefore wise to avoid applying too harsh a quantization to this type of image data.

Next, when an image portion moves over a depth of several images, the quantization can be adjusted as a function of its speed of movement. Thus, if the image portion moves slowly, the quantization must be moderated because the human visual system is capable of detecting these encoding faults more easily than when the movement of an image portion is fast, it then being possible to apply a harsher quantization in the latter case.

Finally, when an image portion is not found in any reference image, or in a number of images that is below a predefined threshold, the display of the object represented in this image portion can then be considered to be fleeting enough for it to be impossible for the human observer to discern encoding artifacts easily. In this case, the quantization can therefore be increased. This is for example the case with the block 315 of the first image I₀, which contains data that are not referenced by any source block.

The dynamic quantization method according to the invention adapts to each of these situations to distribute the available bitrate in such a way as to improve the visual rendition of the encoded stream.

FIG. 4 shows the steps of an example of a dynamic quantization method according to the invention. The method comprises a first step 401 of estimating the motion of the image portions in the video stream. The result of this step 401 generally manifests itself as the production of one or more motion vectors. This step is illustrated in FIG. 3 described above.

In a second step 402, the method makes use of the motion estimation previously carried out to allocate a rating to each source block as a function of one or more criteria among, for example, the following criteria:
the number of times that the data of this source block have been found in reference images; in other words, the number of references from this source block;
the amplitude of movement indicated by the motion vectors;
the prediction error, obtained during the motion estimation, and associated with the referencing of this source block in the reference images.

The rating allocated to the block corresponds to a level of adjustment to be carried out on the quantization of the block. This adjustment can be an increase in the quantization coefficients or a reduction in these coefficients, for example by applying a multiplier coefficient to the quantization coefficients as computed in the absence of the method according to the invention.

By way of illustration, an example of rating will now be presented using the blocks of FIG. 3. Three ratings are defined: PLUS, NEUTRAL, and MINUS. The PLUS rating means that the quantization must be increased (i.e. that the encoding quality can be deteriorated), the NEUTRAL rating means that the quantization must be preserved, and the MINUS rating means that the quantization must be decreased (i.e. that the encoding quality must be improved).

The block 323 of the second image P₂, which contains image data that are fixed in time, is rated MINUS because the quantization must be decreased to preserve an acceptable quality over an image portion that is fixed or quasi-fixed in time.

The block 330 of the third image B₁, which is referenced by the second image P₂ and by the first image I₀, is rated NEUTRAL, because although the object represented in this block is not fixed, it is referenced by several images, therefore its quantization must be maintained.

The block 325 of the second image P₂, which is not referenced by any block and is not used as a reference in any other image, is rated PLUS, since harsher quantization of this block will not greatly alter visual impressions of this block, which appears only briefly.

Thus, according to this implementation, the level of quantization is decreased for image data that are fixed or quasi-fixed in time, maintained for image data that are mobile and increased for image data that are disappearing. The depth, in number of images, from which an object is considered to be fixed can be adjusted (for example four or eight images).

According to other embodiments, other more sophisticated rating systems comprising several levels of gradation are implemented, thereby making it possible to adjust the level of quantization more finely.

In a third step 403, the quantization of each block is adjusted as a function of the rating that has been allocated to them in the second step 402. In the example, the quantization coefficients to be applied to a block rated PLUS are increased; the quantization coefficients to be applied to a block rated NEUTRAL are maintained; the quantization coefficients to be applied to a block rated MINUS are decreased. In this way, the distribution of bitrate between the blocks to be encoded takes account of the evolution of the images represented over time.

By way of illustration, for a video stream containing a scene undergoing a uniform translational motion (traveling) from left to right with an overlay of a fixed logo in the video, the blocks of the left edge of the image are deteriorated because they disappear gradually from the field of the video, and the blocks of the logo are preserved due to their fixed nature. Thus, compared with a conventional quantization method, the method according to the invention removes quantization bits from the dynamic areas whose encoding defects are barely perceptible by an observer toward the areas that are visually sensitive for this observer.

According to a first implementation of the quantization method according to the invention, the quantization modifications carried out in the third step 403 do not take account of any bitrate setpoint provided by the encoder.

According to a second implementation, the adjustments to be made in the distribution of the levels of quantization to be applied to the blocks of an image or a group of images can be modified to take account of a bitrate setpoint provided by the encoder. For example, if a setpoint is provided to force the encoder not to exceed a maximum level of bitrate, that the second step 402 recommends an increase in the quantization of the first blocks and a decrease in the quantization for the second blocks, it may be wise to decrease the quantization of the second blocks to a lesser extent, by preserving the increase in the quantization anticipated for the first blocks.

Furthermore, the modification in the distribution of the quantizations carried out can be made over a set of blocks contained in a single image or over a set of blocks contained in a series of images, for example over a group of images, or a “Group Of Pictures” (GOP) in the MPEG sense. Thus, the first step 401 and the second step 402 can be executed in succession over a series of images before executing the third step 403 of modification of the quantizations concomitantly over all the images from the series.

The dynamic quantization method according to the invention can for example be employed in H.264/MPEG4-AVC encoders or transcoders of HD (high definition) or SD (standard definition) video streams, without, however, being limited to the H.264 standard, the method being generally usable for the encoding of streams including data to be transformed and quantized, whether these data are images, image segments, or more generally sets of pixels that can take the form of blocks. The method according to the invention is also applicable to encoded streams of other standards such as MPEG2, H265, VP8 (of Google Inc., Ltd) and DivX HD+.

1. A method for dynamic quantization of an image stream including transformed blocks, the method comprising a step for establishing a relationship of prediction (V₁₂, V₁₀, V₂₀) between at least one temporal predictive encoding source block of a first image (B₁, P₂) and one or more reference blocks belonging to other images (I₀, P₂), said method further comprising, for at least one of said transformed blocks, a step of quantization of said block wherein the level of quantization applied to this block is chosen at least partly as a function of a variable representing the total number of relationships (V₁₂, V₁₀, V₂₀) established between this block and blocks belonging to the earlier and later images within a group of images.

2. The dynamic quantization method as claimed in claim 1, wherein the level of quantization applied to said block to be quantized is increased if a number of relationships (V₁₂, V₁₀, V₂₀) that is below a predetermined threshold have been established between this block and blocks belonging to other images or if no relationship has been established.

3. The dynamic quantization method as claimed in claim 1 wherein the level of quantization applied to said block to be quantized is decreased, if a number of relationships (V₁₂, V₁₀, V₂₀) that is above a predetermined threshold have been established between this block and blocks belonging to other images.

4. The dynamic quantization method as claimed in claim 1, wherein said transformed block to be quantized is a source block, at least one of said relationships (V₁₂, V₁₀, V₂₀) being a motion vector indicating a movement, between the first image containing said source block and the image containing the block referenced by said relationship, of objects represented in the area delimited by the source block, wherein the level of quantization is chosen at least partly as a function of the movement value indicated by said vector (V₁₂, V₁₀, V₂₀).

5. The dynamic quantization method as claimed in claim 4, wherein the level of quantization applied to said block to be quantized is increased if the movement indicated by said vector (V₁₂, V₁₀, V₂₀) is above a predefined threshold.

6. The dynamic quantization method as claimed in claim 4, the level of quantization applied to said block to be quantized is decreased if the movement indicated by said vector (V₁₂, V₁₀, V₂₀) is below a predefined threshold.

7. The dynamic quantization method as claimed in claim 1, wherein the level of quantization applied to a block included in an image (I₀) not comprising any temporal predictive encoding block is increased if no relationship has been established between this block and a temporal predictive encoding block of another image (P₂, B₁).

8. The dynamic quantization method as claimed in claim 1, the step of creating the relationships (V₁₂, V₁₀, V₂₀) between a temporal predictive encoding source block of a first image (B₁, P₂) and one or more reference blocks generating a prediction error depending on the differences in the data contained by the source block and by each of the reference blocks, wherein the level of quantization of said block to be quantized is modified according to the value of said prediction error.

9. A method for encoding a stream of images forming a video, comprising a step of transforming the images by blocks, comprising the execution of a dynamic quantization method as claimed in claim 1.

10. The method for encoding a stream of images forming a video as claimed in claim 9, said encoding method comprising a prediction loop for estimating a motion of data represented in the blocks, wherein the step of creating the relationships (V₁₂, V₁₀, V₂₀) between a temporal predictive encoding source block of a first image (B₁, P₂) and one or more reference blocks is carried out by said prediction loop.

11. The method for encoding a stream of images forming a video as claimed in claim 10, wherein the stream is encoded according to an MPEG standard.

12. The method for encoding a stream of images as claimed in claim 11, wherein the dynamic quantization method is applied cyclically over a reference period equal to one group of MPEG pictures.

13. An MPEG video encoder configured to execute the encoding method as claimed in claim 10.
